(19) United States
(12) Patent Application Publication
(10) Pub. No.: US 2006/0221237 A1
(43) Pub. Date: Oct. 5, 2006

(54) Display apparatus and control method thereof

(75) Inventors: Seon-hwa Min, Seoul (KR); Han-sung Kim, Incheon city (KR); Hyung-gyu Park, Yongin-si (KR); Dong-hun Lee, Yangju-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/294,485

(22) Filed: Dec. 6, 2005

(30) Foreign Application Priority Data
Mar. 9, 2005 (KR) 2005-0019671

(51) Int. Cl. H04N 5/45; H04N 9/74

(52) U.S. Cl. 348/565; 348/588

(57) ABSTRACT

The present invention relates to a display apparatus comprising a display part on which a picture based on a video signal is displayed, further comprising a signal processor for processing the video signal; a user selection part for enabling a user to set a part of a full picture displayed on the display part as a selected part; and a controller for controlling the signal processor to process the video signal corresponding to the full picture to be displayed as a first picture on a first area and the video signal corresponding to the selected part to be displayed as a second picture on a second area when the selected part is set through the user selection part.

### PRIORITY

This application claims the benefit under 35 U.S.C. 119(a) of Korean Patent Application No. 2005-0019671, filed Mar. 9, 2005, in the Korean Intellectual Property Office, the entire contents of which are incorporated herein by reference.

### BACKGROUND OF THE INVENTION

1. Field of the Invention

The present invention relates to a display apparatus and a control method thereof. More particularly, the present invention relates to a display apparatus and a control method thereof in which a selected part of a picture selected by a user can be displayed in a picture-in-picture (PIP) mode or a picture-by-picture (PBP) mode.

2. Description of the Related Art

As display apparatuses have developed to vary in functionality, display apparatuses can process various video signals output from various signal sources such as a digital versatile disc (DVD) player, a set-top box, a personal computer (PC), and so on and display a picture based on the processed video signal.

Due to the various types of signal sources, a display apparatus capable of supporting zoom and pan functions to enlarge or reduce a part of a picture displayed on a full screen thereof in accordance with a user's requirements has been proposed.

Here, the zoom function enlarges a picture to a predetermined size and enlarges the enlarged picture on a full screen. For example, when a user sets the zoom function for a predetermined magnification size (e.g., four times) through an on screen display (OSD) menu, a picture is enlarged by four times the original size and then displayed on the full screen. Further, the pan function allows a user to select a part of the enlarged picture to be displayed on the full screen. For example, when a user sets the pan function by manipulating up, down, left and right items of the OSD menu, the displayed picture is moved up, down, left and right, respectively.

However, in conventional display apparatuses, only a part of the enlarged picture is displayed on the full screen, so that a user has to move the enlarged picture up, down, left and right in order to see the other parts of the enlarged picture. That is, it is impossible for a user to see both the full picture and a selected part of the enlarged picture at the same time.

Further, in the conventional display apparatus capable of supporting the PIP mode or the PBP mode, signals from the plurality of signal sources are individually processed and then displayed as pictures at the same time. Currently the pictures displayed at the same time have different signal sources.

### SUMMARY OF THE INVENTION

Accordingly, it is an object of the present invention to provide a display apparatus and a control method thereof, in which a selected part of a picture selected by a user can be enlarged or reduced for display on a predetermined area of a full screen together with the picture displayed on the full screen of the display apparatus in a Picture in Picture (PIP) mode or a Picture by Picture (PBP) mode.

Additional, exemplary aspects and/or advantages of the invention will be set forth in part in the description, which follows and, in part, will be obvious from the description, or may be learned by practice of the invention.

The foregoing and/or other exemplary aspects of the present invention are achieved by providing a display apparatus comprising a display part in which a picture based on a video signal is displayed, further comprising a signal processor for processing the video signal; a user selection part for allowing a user to set a part of a full picture displayed on the display part as a selected part; and a controller for controlling the signal processor to process the video signal corresponding to the full picture to be displayed as a first picture on a first area and the video signal corresponding to the selected part to be displayed as a second picture on a second area when the selected part is set through the user selection part.

According to an exemplary aspect of the present invention, the controller has display position information about the first and second areas and display size information about the first and second pictures, and controls the signal processor to display the first and second pictures on the display part on the basis of the display position information and the display size information.

According to an exemplary aspect of the present invention, the user selection part further comprises a menu generator for generating selection menus for allowing a user to select at least one of the display position information and the display size information, and the controller controls the signal processor to display the first and second pictures on the display part on the basis of the selected information when a user selects at least one of the display position information and the display size information.

According to an exemplary aspect of the present invention, the controller controls the menu generator to generate and display the selection menus on the display part when the selected part is set through the user selection part.

According to an exemplary aspect of the present invention, the display size information comprises information about an aspect ratio of at least one of the first and second pictures.

According to an exemplary aspect of the present invention, the first and second areas are set by dividing the display part in a horizontal or vertical ratio of 1:1.

According to an exemplary aspect of the present invention, the controller controls the signal processor to display a picture corresponding to the selected part as the second picture on the second area when a user sets a part of the first picture as the selected part.

According to an exemplary aspect of the present invention, the user selection part comprises at least one of a remote controller and an input button provided in the display apparatus.

According to an exemplary aspect of the present invention, the user selection part implements setting the selected part on the basis of an external signal transmitted from an external device, the external device comprises at least one of a mouse and a keyboard.

According to an exemplary aspect of the present invention, the signal processor comprises a first signal processor for processing a video signal corresponding to the first picture, and a second signal processor for processing a video signal corresponding to the second picture.

The foregoing and/or other exemplary aspects of the present invention are achieved by providing a method of controlling a display apparatus comprising a display part for displaying a picture corresponding to a video signal thereon, the method comprising selecting a part of a full picture displayed on the display part as a selected part; and controlling a video signal corresponding to the full picture to be processed and displayed as a first picture on a first area and a video signal corresponding to the selected part to be processed and displayed as a second picture on a second area.

According to an exemplary aspect of the present invention, the method further comprises selecting display position information and display size information about the first and second pictures, wherein the displaying the first and second pictures on the display part comprises displaying of the first and second pictures on the display part on the basis of the display position information and the display size information.

According to an exemplary aspect of the present invention, the displaying of the first and second pictures on the display part comprises displaying the first and second pictures on the display part divided in a ratio of 1:1, respectively.

According to an exemplary aspect of the present invention, the method further comprises controlling a video signal corresponding to the selected part as the second picture when a part of the first picture is set as the selected part.

According to an exemplary aspect of the present invention, the method further comprises generating selection menus for selecting at least one of the display position information and the display size information about the first and second pictures to be displayed on the display part.

### BRIEF DESCRIPTION OF THE DRAWINGS

These and other aspects and advantages of the present invention will become apparent and more readily appreciated from the following description of exemplary embodiments, taken in conjunction with the accompany drawings of which:

FIG. 1 is a control block diagram of a display apparatus according to an exemplary embodiment of the present invention;

FIGS. 2 and 3 respectively show pictures displayed in Picture in Picture (PIP) and Picture by Picture (PBP) modes on a display part of the display apparatus according to an exemplary embodiment of the present invention; and

FIG. 4 is a control flowchart of the display apparatus according to an exemplary embodiment of the present invention.

Throughout the drawings, the same or similar elements are denoted by the same reference numerals.

### DETAILED DESCRIPTION OF EXEMPLARY EMBODIMENTS

Reference will now be made in detail to exemplary embodiments of the present invention, examples of which are illustrated in the accompanying drawings.

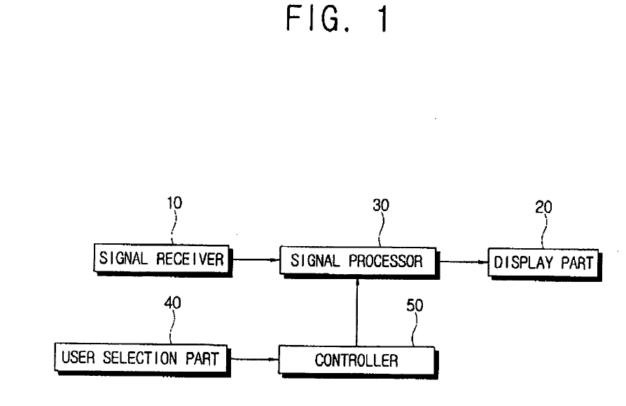

FIG. 1 is a control block diagram of a display apparatus according to an exemplary embodiment of the present invention.

As shown in FIG. 1, a display apparatus according to an exemplary embodiment of the present invention comprises a signal receiver 10, a display part 20, a signal processor 30, a user selection part 40, and a controller 50.

The signal receiver 10 receives a video signal from a signal source. Here, the video signal comprises a broadcasting signal from a broadcasting station and/or an external signal from an external signal source. Thus, the signal receiver 10 comprises an antenna for receiving the broadcasting signal, a tuner for tuning a broadcasting channel, and an input terminal to which a connection cable from the external signal source is connected. For example, the signal receiver 10 comprises a plurality of input terminals to which various signals such as an S-video signal, a component signal, a personal computer (PC) signal, a digital video interface (DVI) signal and the like can be input from various external signal sources.

The display part 20 displays a picture based on the video signal output from the signal processor 30. Here, the display part 20 comprises a display panel on which a picture is displayed, and a panel driver for driving the display panel to display a picture thereon on the basis of the video signal outputted from the signal processor 30. According to an exemplary embodiment of the present invention, the display part 20 can be achieved by various display modules such as a digital light processing (DLP), a liquid crystal display (LCD), a plasma display panel (PDP), and so on.

The signal processor 30 converts the video signal received through the signal receiver 10 into a signal having a format suitable for the display part 20.

According to an exemplary embodiment of the present invention, the signal processor 30 comprises a processing circuit for modulating and demodulating the broadcasting signal, a decoder for decoding a composite video baseband signal (CVBS) signal or an S-video signal, an analog/digital converter for converting an analog signal such as a component signal or a PC signal into a digital signal, a transition minimized differential signaling (TMDS) receiver for dividing a DVI signal into red, green and blue (RGB) digital signals and horizontal/vertical (H/V) synchronous signals, and the like.

Further, the signal processor 30 comprises a scaler or the like to convert the signal converted by the decoder or the converter into a signal having a vertical frequency, a resolution, an aspect ratio, and so on suitable for the output of the display part 20. Additionally, the signal processor 30 comprises a frame buffer unit for storing frame information about the video signal received through the signal receiver 10.

According to an embodiment of the present invention, the display apparatus supports a PIP mode or a PBP mode. Thus, the signal processor 30 further comprises a plurality of signal processing blocks for individually processing the video signals corresponding to respective pictures in order to implement the PIP mode or the PBP mode. Each signal processing block controls each scaler for processing a video signal and adjusting the displaying position and the displaying size of a picture to be displayed on the display part 20.

For example, it can be assumed that the signal processor 30 comprises two signal processing blocks, such as a first scaler and a second scaler. When the controller 50 gives a command to display a picture corresponding to a selected area in the PIP mode or the PBP mode, the first scaler processes a video signal corresponding to the full picture to be displayed as a first picture on a first area in accordance with a default set or the displaying position/displaying size given by the controller 50. Further, the second scaler receives a video signal corresponding to a selected part from data stored in the frame buffer unit on the basis of coordinate data about the selected part given by the controller, and processes a video signal corresponding to the selected part to be enlarged or reduced and then displayed as a second picture on a second area in accordance with the default set or the displaying position/displaying size given by the controller 50. Therefore, the first picture is displayed as a still or moving picture corresponding to the full picture, and the second picture is displayed as a still or moving picture corresponding to the selected part.

The user selection part 40 allows a user to select a part of the full picture displayed on the display part 20. Here, the user selection part 40 can be achieved by a manipulation key, a button, a touch screen, and so on provided in a remote control or a main casing of a display apparatus. Further, a user can set the PIP mode or the PBP mode for the selected part through an input key or the like provided in the user selection part 40 before or after setting the selected part.

Using the input key provided in the remote controller or the main casing of the display apparatus, a user set the selected part to be displayed in the PIP or PBP mode. Here, information about the selected part can be transmitted as the coordinate data, such as a start point and an end point of the selected part to the controller 50.

Further, the user selection part 40 further comprises a menu generator for allowing a user to select information about the display positions of the first and second areas, and information about the display sizes of the first and second pictures.

The menu generator generates a menu comprising selection menus for the display positions of the first area and/or the second area and for the display sizes of the first picture and/or the second picture, thereby outputting them to the scaler. Then, the scaler converts the generated selection menus to have a predetermined format suitable for being displayed on the display part 20.

Here, the display position indicates a place where the first and second pictures are displayed on the display part 20, and the display size indicates the sizes of the first and second pictures displayed depending on the enlargement, the reduction or the aspect ratio. Alternatively, the menu may comprise selection menus corresponding to various display positions and various display sizes.

Thus, a user can select or input a desired display position and a desired display size through the menu displayed by manipulating the user selection part 40.

Further, the user selection part 40 allows a user to select the selected part according to external signals transmitted from external devices. Also, a mouse and/or a keyboard connected to the external signal source such as the PC can transmit point coordinate data of the selected part from the external signal source to the display apparatus through a predetermined interface.

When a part of the full picture is set as the selected part by manipulating the user selection part 40, the controller 50 controls the signal processor 30 to display not only a video signal corresponding to the full picture as the first picture on the first area but also a video signal corresponding to the selected part as the second picture on the second area on the basis of the information about a predetermined display position and a predetermined display size. Here, the controller 50 can be embodied by a micro-controller unit (MCU), a microprocessor unit (MPU), or the like, wherein each of the MCU and the MPU stores a corresponding program therein. The controller 50 preferably calculates the coordinate data on the basis of the selected part information, the display position information, and the display size information.

When the coordinate data about the selected part set through the user selection part 40 is transmitted to the controller 50, the controller 50 controls the menu generator to display the selection menus about the display position information and the display size information. Further, the controller 50 controls the scaler to enlarge or reduce the video signals corresponding to the full picture and the selected part on the basis of the display position information and the display size information selected from among the selection menus through the user selection part 40.

Also, the controller 50 can be programmed to generate the selection menus at the same time when the selected part is set. Further, when a user does not select the menu, the controller 50 can control pictures to be displayed in the PIP or PBP modes on the basis of the position and size information of the default set.

According to an exemplary embodiment of the present invention, when a user sets a part of the first picture displayed on the first area as the selected part and wants to make the selected part be displayed as a separate picture even though the full picture and the selected part are displayed in the PIP or PBP mode, the controller 50 provides the second scaler with the data about the selected part and the information about both the display position and the display size, thereby replacing the second picture with a picture corresponding to the selected part reselected by a user.

Further, while the pictures based on the respective signals received from the plurality of signal sources are displayed in the PIP or PBP mode, when a part of a picture corresponding to one source is set as the selected part through the user selection part 40, the controller 50 controls the picture corresponding to the selected part to be enlarged or reduced into a picture having a predetermined size, so that the picture corresponding to the selected part can be displayed in the PIP or PBP mode together with the picture corresponding to one source. Here, a picture corresponding to the rest of the source may be not displayed. Also, the picture corresponding to the selected part may be displayed on a picture area for the rest source.

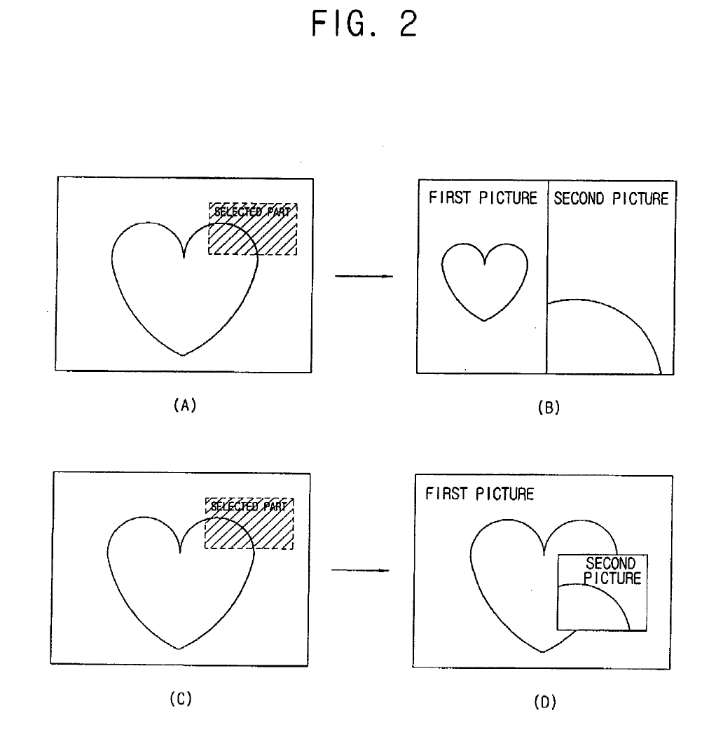

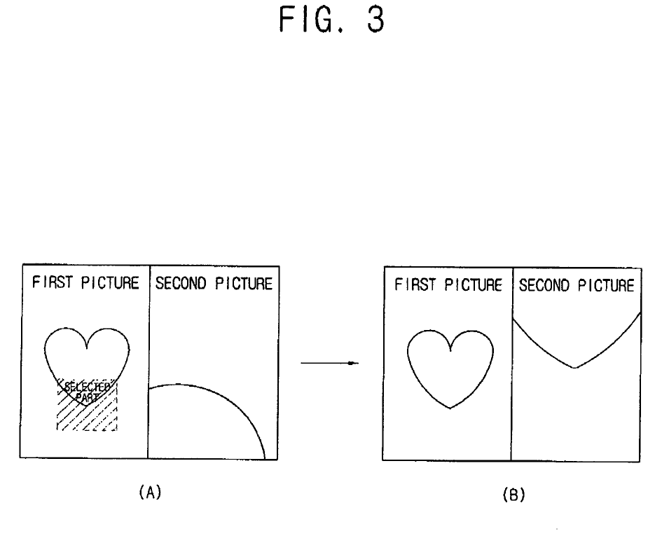

Hereinbelow, the display areas of the first and second pictures will be displayed with reference to FIGS. 2 and 3.

Referring to (A) and (B) of FIG. 2, when a part of the full picture is set as the selected part, the first picture corresponding to the full picture and the second picture corresponding to the selected part of the full picture are displayed in the PBP mode on the display part 20 and vertically divided in a ratio of 1:1.

Referring to (C) and (D) of FIG. 2, the first picture corresponding to the full picture is displayed on a full screen of the display part 20, and the second picture corresponding to the selected part is displayed in the PIP mode on a predetermined area of the display part 20.

Alternatively, as shown in FIG. 3, while the first picture corresponding to the full picture and the second picture corresponding to the selected part are displayed, when a user sets another selected part, the second picture can be replaced with a picture corresponding to another selected part newly set by a user.

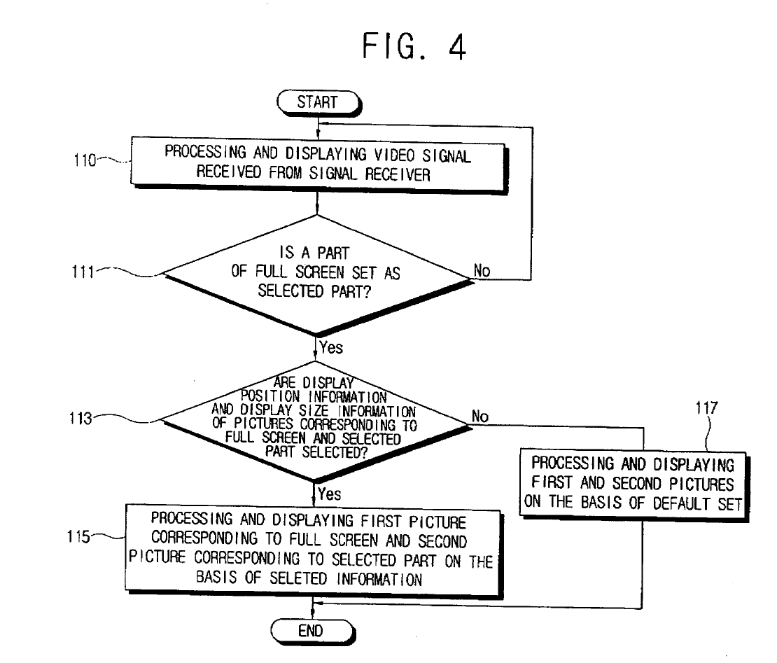

In the meantime, a control flow of a display apparatus according to an exemplary embodiment of the present invention will be described hereinbelow with reference to FIG. 4.

As shown in FIG. 4, at operation 110, the display apparatus processes a video signal received from the signal receiver 10 and displays a picture based on the processed video signal. In this state, at operation 111, a user manipulates the user selection part 40 and sets a part of a currently displayed picture as the selected part for the PIP or the PBP mode, so that the coordinate data corresponding to the selected part is transmitted to the controller 50.

Further, the controller 50 controls the menu generator to output the selection menus for the display position and the display size of the first and second pictures to the scaler, thereby allowing the scaler to process data corresponding to the selection menus and display it as a menu picture on the display part 20. In this operation, the controller 50 may be automatically operated as the selected part is set or as a user selects the selection menus through the user selection part 40.

When a user selects at least one of the display position information and the display size information corresponding to the full picture and the selected part through the user selection part 40 at operations 113, the user selection part 40 transmits the corresponding data to the controller 50. At operation 115, the controller 50 controls the first and second scalers to process the video signals corresponding to the full picture and the selected part on the basis of the transmitted data, thereby displaying the pictures based on the processed video signals in the PIP or PBP modes.

When a user doe not select the information about the display position and the display size, at operation 117, the controller controls the first and second pictures to be displayed in the PIP or PBP mode on the basis of the default set.

Meanwhile, when a user reselects another selected part while the first and second pictures are displayed in the PIP or PBP mode, the second picture can be replaced with another selected part reselected by a user.

As described above, this exemplary embodiment of the present invention provides a display apparatus and a control method thereof, in which a selected part of a picture selected by a user can be enlarged or reduced to be displayed on a predetermined area of a full screen together with the full picture displayed on the display part in a PIP mode or a PBP mode.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display apparatus comprising a display part on which a picture based on a video signal is displayed, further comprising:
a signal processor for processing the video signal;
a user selection part for allowing a user to set a part of a full picture displayed on the display part as a selected part; and
a controller for controlling the signal processor to process the video signal corresponding to the full picture to be displayed as a first picture on a first area and the video signal corresponding to the selected part to be displayed as a second picture on a second area when the selected part is set through the user selection part.

2. The display apparatus according to claim 1, wherein the controller has display position information about the first and second areas and display size information about the first and second pictures, and controls the signal processor to display the first and second pictures on the display part on the basis of the display position information and the display size information.

3. The display apparatus according to claim 2, wherein the user selection part further comprises a menu generator for generating selection menus for allowing a user to select at least one of the display position information and the display size information, and
the controller for controlling the signal processor to display the first and second pictures on the display part on the basis of the selected information when a user selects at least one of the display position information and the display size information.

4. The display apparatus according to claim 3, wherein the controller controls the menu generator to generate and display the selection menus on the display part when the selected part is set through the user selection part.

5. The display apparatus according to claim 3, wherein the display size information comprises information about an aspect ratio of at least one of the first and second pictures.

6. The display apparatus according to claim 2, wherein the first and second area are set by dividing the display part in a horizontal or vertical ratio of 1:1.

7. The display apparatus according to claim 2, wherein the controller controls the signal processor to display a picture corresponding to the selected part as the second picture on the second area when a user sets a part of the first picture as the selected part.

8. The display apparatus according to claim 1, wherein the user selection part comprises at least one of a remote controller and an input button provided in the display apparatus.

9. The display apparatus according to claim 1, wherein the user selection part implements setting the selected part on the basis of an external signal transmitted from an external device, the external device comprises at least one of a mouse and a keyboard.

10. The display apparatus according to claim 1, wherein the signal processor comprises a first signal processor for processing a video signal corresponding to the first picture, and a second signal processor for processing a video signal corresponding to the second picture.

11. A method of controlling a display apparatus comprising a display part for displaying a picture corresponding to a video signal thereon, the method comprising:
selecting a part of a full picture displayed on the display part as a selected part; and
controlling a video signal corresponding to the full picture to be processed and displayed as a first picture on a first area and a video signal corresponding to the selected part to be processed and displayed as a second picture on a second area.

12. The method according to claim 11, further comprising;
selecting display position information and display size information about the first and second pictures,
wherein the displaying of the first and second pictures on the display part comprises displaying the first and second pictures on the display part on the basis of the display position information and the display size information.

13. The method according to claim 12, wherein the displaying of the first and second pictures on the display part comprises:
displaying the first and second pictures on the display part divided in a ratio of 1:1, respectively.

14. The method according to claim 12, further comprising:
controlling a video signal corresponding to the selected part as the second picture when a part of the first picture is set as the selected part.

15. The method according to claim 11, further comprising:
generating selection menus for selecting at least one of the display position information and the display size information about the first and second pictures to be displayed on the display part.
